(19) United States
(12) Patent Application Publication
(10) Pub. No.: US 2010/0059324 A1
(43) Pub. Date: Mar. 11, 2010

(54) Coupling Arrangement, Particularly for a Hydrodynamic Coupling Device

(75) Inventor: Eberhard BIERMANN, Ravensburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/557,621

(22) Filed: Sep. 11, 2009

(30) Foreign Application Priority Data
Sep. 11, 2008 (DE) 10 2008 046 816.9

(51) Int. Cl. F16D 33/00

(52) U.S. Cl. 192/3.29

(57) ABSTRACT

A coupling arrangement, particularly for a hydrodynamic coupling device, including a first friction surface arrangement that is rotatable around an axis of rotation with a housing filled with fluid, a second friction surface arrangement, which is rotatable around the axis of rotation with a driven member, and a pressing arrangement that is actuated by pressure fluid. The first friction surface arrangement and the second friction surface arrangement are brought into frictional engagement by the pressing arrangement. The pressing arrangement includes an annular piston element that is movable in its radial inner area in a fluid-tight manner in direction of the axis of rotation on a guide disk element which is secured to an inner side of the housing.

### BACKGROUND OF THE INVENTION

1. Field of the Invention

The present invention is directed to a coupling arrangement, particularly a hydrodynamic coupling device, including a first friction surface arrangement which is rotatable around an axis of rotation with a housing to be filled with fluid, a second friction surface arrangement which is rotatable around the axis of rotation with a driven member, and a pressing arrangement which can be actuated by a pressure fluid, wherein the first friction surface arrangement and the second friction surface arrangement are brought into frictional engagement by the pressing arrangement. The pressing arrangement comprises an annular piston element.

2. Description of the Related Art

In hydrodynamic torque converters, so-called lockup clutches are used as coupling arrangements for producing a direct mechanical torque transmission connection between the housing thereof and an output hub. The two friction surface arrangements are pressed into mutual frictional engagement by a coupling piston when a direct mechanical torque transmission connection of this kind is produced. The annular piston element impinges, generally in its radial outer area, on one of the friction surface arrangements. In its radial inner area, the piston element is movably guided on a cover hub in a fluid-tight manner. The cover hub is welded into a central cutout of a housing shell on the engine side and, together with it, forms an outer circumferential guide surface for the piston element and, a bearing journal which can be positioned at the outer side of the housing so as to engage in a corresponding bearing cutout in a crankshaft or other drive shaft. When the piston element impinges on the second friction surface arrangement or on a friction element thereof, a disk-like carrier element can be additionally provided for producing a rotationally rigid connection of the piston element to the housing, this disk-like carrier element being secured welded, in its radial inner area to the cover hub and a plurality of tangential leaf springs, or the like, are connected to the piston element in the radial outer area of the disk-like carrier element so that it is connected to the housing hub, and accordingly to the entire housing, so as to be fixed with respect to rotation relative to it and, an axial force can also be generated by the tangential leaf springs at the same time, by means of which the piston element is preloaded in the engagement direction or release direction.

The housing hub which is designed for guiding the piston element and for supporting the entire hydrodynamic torque converter with respect to a drive shaft is comparatively complicated to produce, for example, by a casting method, which requires subsequent finishing machining. Further, the process of connecting this housing hub to the housing shell on the engine side must be carried out by a time-consuming welding process because a weld running circumferentially and annularly along the connection area must be produced without causing a deformation of the housing, that is, of the engine-side housing shell that is connected in this way.

### SUMMARY OF THE INVENTION

It is an object of the present invention to provide a coupling arrangement for a hydrodynamic coupling device such as a hydrodynamic torque converter, in which fluid-tight movement of the annular piston element is ensured in a simple and reliable manner.

According to one embodiment of the invention, this object is met through a coupling arrangement, particularly for a hydrodynamic coupling device, comprising a first friction surface arrangement which is rotatable around an axis of rotation with a housing to be filled with fluid, a second friction surface arrangement which is rotatable around the axis of rotation with a driven member, and a pressing arrangement which can be actuated by pressure fluid, wherein the first friction surface arrangement actuatable and the second friction surface arrangement can be brought into frictional engagement by the pressing arrangement. The pressing arrangement comprises an annular piston element that is movable in its radial inner area in a fluid-tight manner in direction of the axis of rotation on a guide disk element secured to an inner side of the housing.

Accordingly, the coupling arrangement constructed according to one embodiment of the invention includes a guide disk element connected to the inner side of the housing guides and seals the piston element at its radial inner area. In this way, it is possible to manufacture the housing with a continuous housing shell and not one penetrated by openings which must be subsequently closed. This substantially simplifies the production process. Further, owing to the fact that the guide disk element that guides the piston element is disk-shaped, that is, has a comparatively flat construction, only a small installation space is required in the interior of the housing.

In its radial outer area, the piston element is preferably movable in a fluid-tight manner at the housing so that a fluid-tight closure is produced on the radial inner side and on the radial outer side.

To provide a sufficiently large surface for the piston element to be acted upon by pressure fluid for a finely metered, defined actuation of the piston element and, correspondingly, of the coupling arrangement, the radial dimensioning of the piston element between its radial outer area and its radial inner area substantially corresponds to the radial dimensioning of the guide disk element between its radial outer area and its radial inner area.

A multiple functionality can be provided in the area of the guide disk element in that the guide disk element has a centering cutout in its radial inner area for receiving the driven member. This simplifies the overall construction because additional structural component parts and assemblies providing a radial centering of the driven member can be omitted. In so doing, for example, the driven member can be received in the centering cutout so as to be rotatable around the axis of rotation in a fluid-tight manner with respect to the guide disk element.

In a particularly advantageous constructional variant, the guide disk element is constructed from sheet metal material, which means that it can easily be provided with the desired shape in a very simple, economical production because sheet metal material can be shaped very simply but with high precision. Accordingly, by means of shaping and, if required, subsequent machining, the guide disk element can be produced from a ring-shaped blank which can also be cut out from a sheet metal panel, for example, by punching.

A fixed connection of the guide disk element to the housing can be carried out by means of a material bond, that is, for example, by welding, and/or by means of a positive engagement, that is, for example, by riveting. The guide disk element is preferably connected by its radial center area to the housing in order to achieve a very stable connection.

To enable the axial movement of the piston element in a simple manner by applying pressure fluid to the piston element, it is further suggested that the guide disk element, together with the housing, forms a flow path for supplying pressure fluid to, and removing pressure fluid from, a pressure fluid space defined by the piston element.

In so doing, the guide disk element can have, for example, a plurality of axial shaped portions and is secured to the housing in the area of the axial shaped portions, the flow path being formed between the axial shaped portions.

In an alternative embodiment, the guide disk element can have a plurality of axial shaped portions and can be secured to the housing between the axial shaped portions, the flow path being formed in the area of the axial shaped portions.

The present invention is further directed to a hydrodynamic coupling device, for example, a hydrodynamic torque converter, comprising a coupling arrangement constructed according to the invention.

For example, an output hub, as driven member, can be arranged so as to engage in the centering cutout.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will be described in more detail in the following with reference to the accompanying drawings.

FIG. 1 is a partial longitudinal cross section through a hydrodynamic torque converter with a coupling arrangement constructed according to one embodiment of the invention;

FIG. 2 is a detail of an alternative construction of the coupling arrangement;

FIG. 3 is a view corresponding to FIG. 1 of another alternative construction; and

FIG. 4 is a view corresponding to FIG. 1 of another alternative type of construction.

### DETAILED DESCRIPTION OF THE PRESENTLY PREFERRED EMBODIMENTS

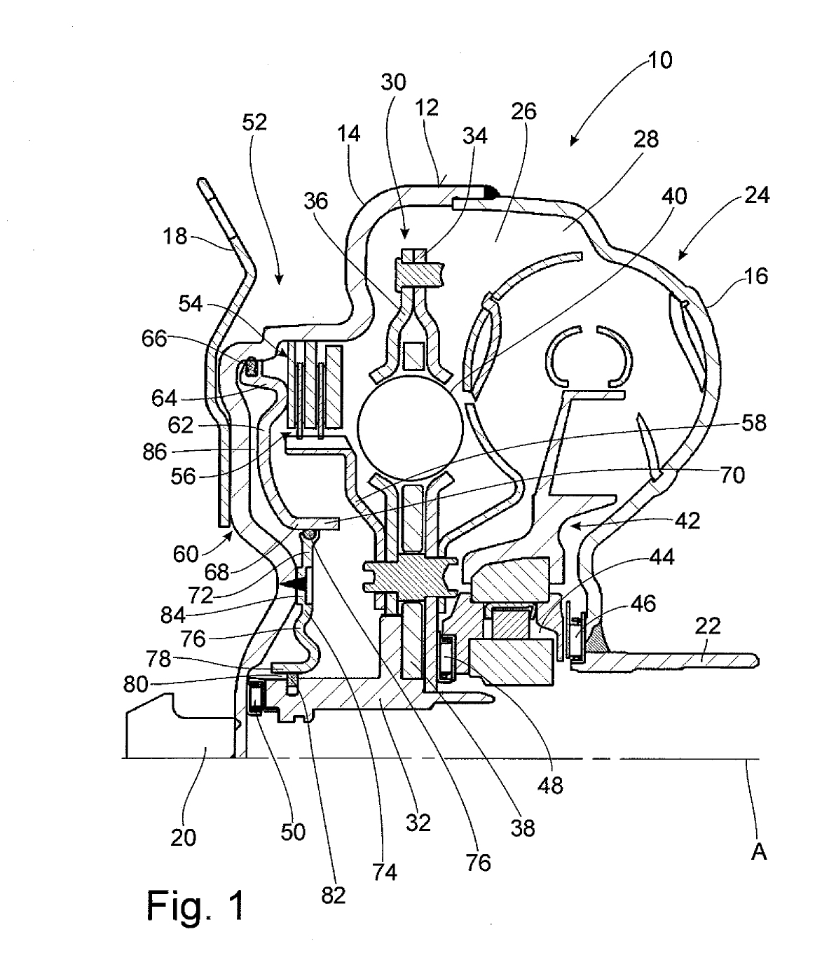

FIG. 1 is a hydrodynamic torque converter, designated in its entirety by 10, which is to be arranged in a drivetrain of a vehicle. The torque converter 10 comprises a housing 12 with a housing shell 14 to be positioned on the engine side and a housing shell 16 to be positioned on the transmission side. The housing 12 is connected to a driveshaft or the crankshaft of an internal combustion engine for rotation around an axis of rotation A by a connection arrangement 18 provided at the housing shell 14 and a flex plate assembly, not shown, or the like. In this state, a bearing journal 20 which is welded to the outer side of the housing shell 14 is positioned so as to engage in an associated bearing cutout of this shaft.

A pump hub 22 is connected on the radial inner side of the housing shell 16 positioned on the transmission side. This pump hub 22 is positioned to engage in a gear unit to drive a fluid pump for example, an oil pump, in the gear unit when the housing 12 rotates. The housing shell 16 on the transmission side, together with a plurality of impeller blades provided thereon, forms an impeller, designated in its entirety by 24, which rotates along with the housing 12 in a corresponding manner when the latter rotates.

A turbine 28 with a plurality of turbine blades provided thereon is arranged in the interior 26 of the housing 12. This turbine 28 is located opposite to the impeller 24. On the radial inner side, the turbine 28 is connected to an output hub 32 by a torsional vibration damper 30. The torsional vibration damper 30 comprises, as primary side, two cover disk elements 34, 36 to which the turbine 28 is also fixedly connected. On a secondary side, the torsional vibration damper 30 comprises a central disk element 38 which is fixedly connected to the output hub 32 or is constructed integral therewith. A damper element arrangement 40 comprises a plurality of damper springs or the like arranged successively in circumferential direction, by means of which a torque can be transmitted between the primary side and the secondary side.

A stator 42 is arranged axially between the impeller 24 and the turbine 28 and is carried on a supporting hollow shaft, not shown, by a freewheeling arrangement 44 in such a way that it can rotate around the axis of rotation A in one direction, but is locked with respect to rotation in the other direction. A first axial bearing 46 is provided between the stator 42 and the housing shell 16 on the transmission side. A second axial bearing 48 is provided between the stator 42 and the torsional vibration damper 30 and output hub 32. A third axial bearing 50 supports the output hub 32 axially at the other housing shell 14.

A coupling arrangement 52, which acts as a lockup clutch in this example comprises a first friction surface arrangement 54 which rotates along with the housing 12 around the axis of rotation A and which has a plurality of disks or annular friction plates. The latter are connected to the housing 12 by a toothed engagement for joint rotation around the axis of rotation A. A second friction surface arrangement 56 which also comprises a plurality of ring-shaped friction elements or disks, for example, is connected to the primary side of the torsional vibration damper 30, that is, the two cover disk elements 34, 36 and the turbine 28, by means of a friction element carrier 58. Regardless of whether a torque is conducted via the coupling arrangement 52 or via the turbine 28 in direction of the output hub 32, this torque transmission is carried out by way of the torsional vibration damper 30.

A pressing arrangement, designated in its entirety by 60, is provided for pressing the two friction surface arrangements 54, 56 into mutual frictional engagement. This pressing arrangement 60 comprises a ring-shaped piston element 62. In its radial outer area 64, where the piston element 62 also loads the two friction surface arrangements 54, 56, the piston element 62 is guided by of a sealing element 66 constructed as an O-ring, or the like, at an axially extending portion of the housing shell 14 so as to be axially movable in direction of the axis of rotation A in a fluid-tight manner. In its radial inner area 68, the piston element 62 forms an annular, cylindrical guide area 70 which is guided so as to be movable axially in direction of the axis of rotation A on the radial outer area 72 of a guide disk element 74, which is constructed annularly, with the intermediary of a sealing element 76 constructed as an O-ring or the like. In its radial inner area 78, the annular guide disk element 74 forms an axially extending centering portion and a centering cutout 80 which is formed therein and in which the output hub 32 engages. A sealing element 82 constructed as a square sealing ring or O-ring and produces a fluid-tight closure between the guide disk element 74 and the output hub 32 so that the output hub 32 is basically radially centered by the guide disk element 74 but is rotatable therein in a fluid-tight manner.

In its radial center area, the guide disk element 74, which is preferably formed by shaping a sheet metal blank, has a plurality of shaped portions 84 successively arranged in circumferential direction. The guide disk element 74 is connected to the housing shell 14 by a material bond in the area of these shaped portions 84, for example, by laser welding or the like.

A flow path by which pressure fluid, that is, for example, oil which is under pressure, can reach a pressure fluid space 86 or can be removed again from the after is formed in circumferential direction between the shaped portions 84 and between the housing shell 14 and the guide disk element 74. This pressure fluid space 86 is formed between the piston element 62 and the housing shell 14. The pressure fluid present in the pressure fluid space 86 loads the piston element 62 in direction of the two friction surface arrangements 54, 56 so as to bring them into frictional engagement and consequently so as to transmit torque for the coupling arrangement 52.

Since the piston element 62 in the construction of the coupling arrangement 60 according to one embodiment of the invention has a radial dimensioning between its radial inner area 68 and its radial outer area 64 which approximately corresponds to the radial dimensioning of the guide disk element 74 between its radial inner area 76 and radial outer area 42, it is possible to produce a comparatively finely metered movement of the piston element 62 when loaded by pressure and, consequently, also a corresponding finely metered influencing of the lockup state of the coupling arrangement 52, i.e., of the lockup clutch. Moreover, since the guide disk element 74 is connected to the inner side of the housing 12, that is, to the housing shell 14 on the engine side, this housing shell 14, without any break or opening, can be provided as a shaped sheet metal part to which the guide disk element 74, and also the bearing projection 20, respectively, are preferably connected by several welds. However, these connection processes are comparatively simple to carry out and do not involve the risk of a heat-induced deformation of the housing 12 or housing shell 14 when connecting.

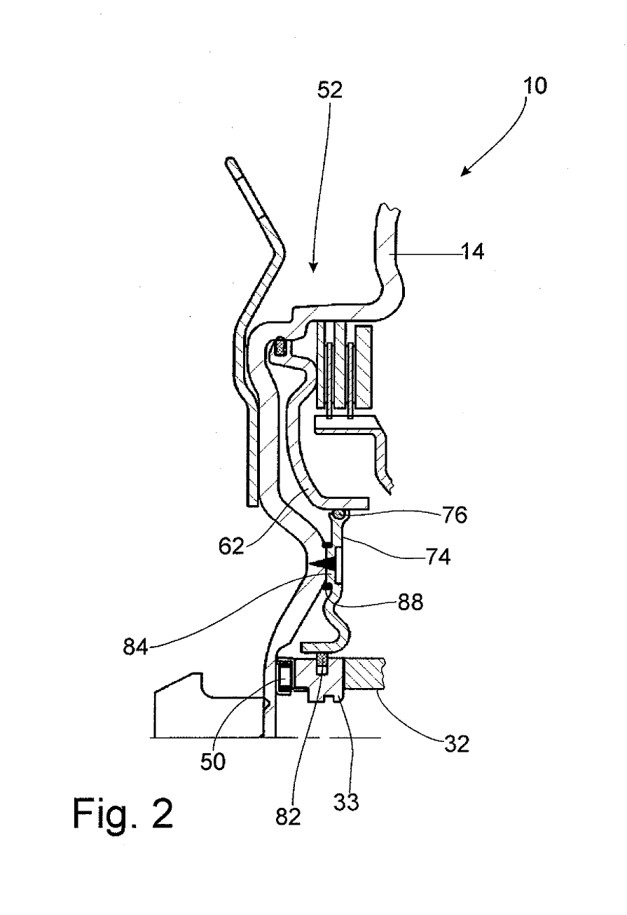

FIG. 2 is a modification of the coupling arrangement 52 shown in FIG. 1. In this case, the construction basically corresponds to that described above, particularly also as far as the torque converter 10 itself is concerned, and reference is had to the preceding description.

It can be seen that, in this case, the axial shaped portions 84 are enclosed by elastomer material 88. This can be provided, for example, together with one or both sealing elements 76 and 82, respectively, by vulcanizing onto the guide disk element 74.

By providing elastomer material 88, it is ensured that no weld material splashes which can possibly lead to damage during later operation can reach the interior of the housing when carrying out the welding connection process by which the guide disk element 74 is connected to the housing shell 14.

FIG. 2 further shows that in this case the output hub 32 has, as a component part, a ring area 33 which is fastened thereto, for example, by welding. The output hub 32 is supported at the axial bearing 50 by means of this ring area 33. Further, this ring 33 serves for sealing with respect to the guide disk element 74 and, toward the radial inner side, also with respect to a transmission input shaft or the like, not shown in FIG. 2. Of course, a construction of this kind could also be selected for the other constructional variants.

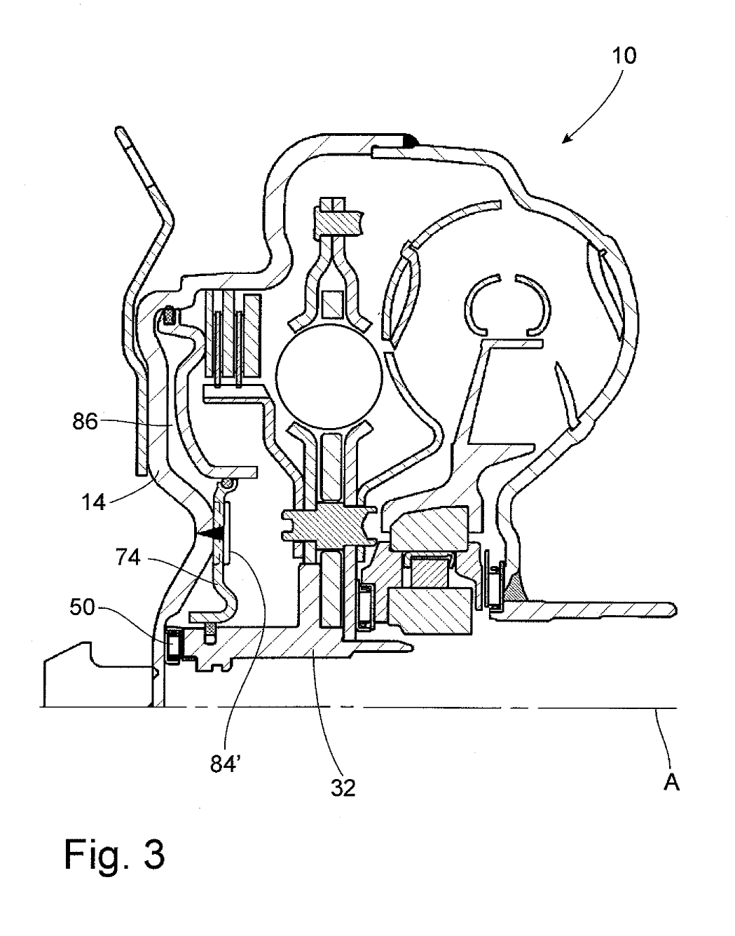

Another embodiment form is shown in FIG. 3. In this case, the construction also corresponds substantially to that described above and reference is had to the description referring to FIG. 1. However, it can be seen from FIG. 3 that the axial shaped portions 84′ are directed away from the housing shell 14. The weld connection between the guide disk element 74 and the housing shell 14 is carried out in circumferential direction in the areas of the guide disk element which are substantially planar, that is, not axially displaced. The axial shaped portions 84′ lie between these connection areas so that passages are again formed between the guide disk element 74 and the housing shell 14 and can serve as a flow path for guiding pressure fluid to and from the pressure fluid space 86. It should be noted that this pressure fluid can be supplied and removed by a transmission input shaft, not shown, or the like which is inserted into the output hub 32 and is coupled with the latter, for example, by a partial toothing for joint rotation around the axis of rotation A. A transmission input shaft of this kind can have a central opening through which the pressure fluid is supplied and removed. The pressure fluid finds its flow path between the output hub 32 and the housing shell 14 through the axial bearing 50 which is not constructed in a fluid-tight manner on principle.

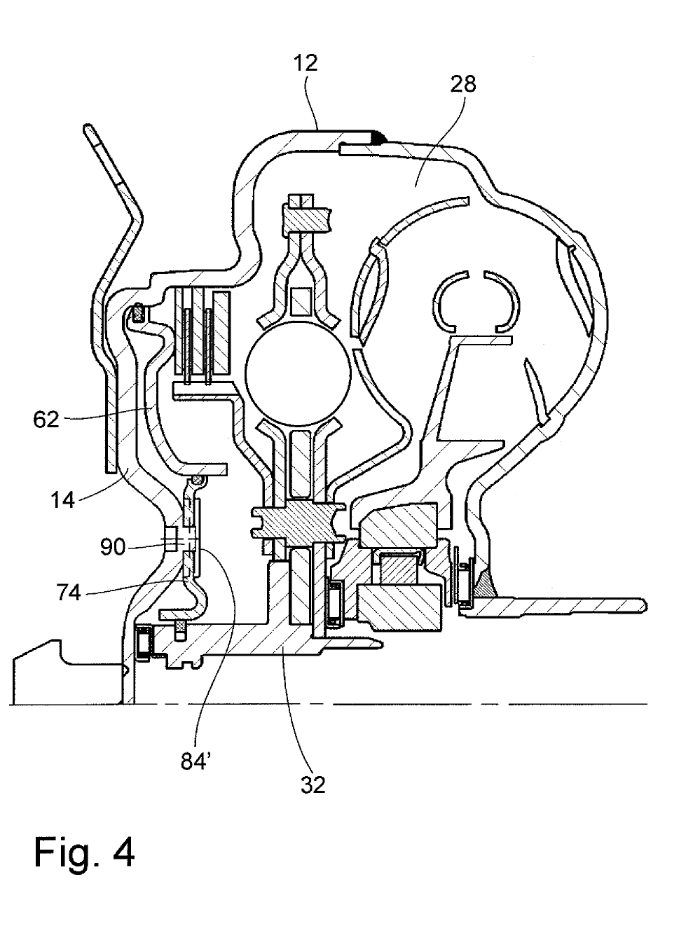

FIG. 4 depicts another embodiment of the invention. In this case also, the axial shaped portions 84′ are directed away from the housing shell 14 so that the connection of the guide disk element 74 to the housing shell 14 is again carried out in the areas between these axial shaped portions 84′. In this case, however, the connection is formed by a positive engagement rather than by a material bond. To this end, rivet bolt portions 90 are formed integrally at the housing shell 14, these rivet bolt portions 90 penetrating through corresponding openings in the guide disk element 74 and engaging behind the guide disk element 74 at the side remote of the housing shell 14. Accordingly, a stable and at the same time also substantially fluid-tight connection can be implemented by means of the positive engagement.

Finally, it should be mentioned that the embodiment forms described above can, of course, be varied in many different ways without deviating from the principles of the present invention. For example, the torsional vibration damper 30 could be constructed differently, for example, in multiple stages with two torsional vibration damper areas staggered in series and arranged radially one inside the other. The turbine 28 and, along with it, the output hub 32 could also be connected directly to the friction surface arrangement 56. Also, the two friction surface arrangements can be varied with respect to the quantity of friction elements provided. Of course, as can also be seen from the drawings, the friction element, e.g., of the first friction surface arrangement 54, lying farthest from the piston element 62 can serve as an abutment which is also fixedly connected axially to the housing 12.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A coupling arrangement for a hydrodynamic coupling device, comprising:
a first friction surface arrangement configured to be rotatable around a first axis of rotation;
a housing configured to be filled with fluid, the housing being rotatable with the first friction surface arrangement about the first axis of rotation;
a second friction surface arrangement configured to be rotatable around the first axis of rotation;
a driven member coupled to the first friction surface arrangement the driven member being rotatable about the first axis of rotation with the second friction surface arrangement; and
a pressing arrangement actuatable by a pressure fluid, the pressing arrangement configured to bring the first friction surface arrangement and the second friction surface arrangement into frictional engagement, the pressing arrangement comprises:
a guide disk element secured to an inner side of the housing; and
an annular piston element configured for movement in its radial inner area in a fluid-tight manner in a direction of the axis of rotation on the guide disk element.

2. The coupling arrangement according to claim 1, wherein the piston element is movable in its radial outer area at the housing in a fluid-tight manner in the direction of the axis of rotation.

3. The coupling arrangement according to claim 2, wherein a radial dimension of the piston element between its radial outer area and its radial inner area substantially corresponds to a radial dimension of the guide disk element between its radial outer area and its radial inner area.

4. The coupling arrangement according to claim 3, wherein the guide disk element comprises a centering cutout in its radial inner area configured for receiving the driven member.

5. The coupling arrangement according to claim 4, wherein the driven member is rotatable around the axis of rotation in a fluid-tight manner with respect to the guide disk element.

6. The coupling arrangement according to claim 1, wherein the guide disk element is constructed from sheet metal material.

7. The coupling arrangement according to claim 1, wherein the guide disk element is connected to the inside of the housing by at least one of a material bond and a positive engagement.

8. The coupling arrangement according to claim 7, wherein the guide disk element is connected in its radial center area to the inside of the housing.

9. The coupling arrangement according to claim 7, further comprising a flow path for supplying and removing pressure fluid from a pressure fluid space defined by the piston element, wherein the flow path is formed by at least the guide disk element and the housing.

10. The coupling arrangement according to claim 9, wherein the guide disk element comprises a plurality of axial shaped portions, the guide disk element being secured to the inside of the housing in the areas of the plural axial shaped portions, wherein the flow path is formed between the plural axial shaped portions.

11. The coupling arrangement according to claim 9, wherein the guide disk element comprises a plurality of axial shaped portions and the guide disk element is secured to the inside of the housing between the plural axial shaped portions, wherein the flow path is formed in the area of the plural axial shaped portions.

12. A hydrodynamic coupling device, configured as a torque converter, comprising the coupling arrangement according to claim 1.

13. A hydrodynamic coupling device comprising the coupling arrangement according to claim 5, wherein the driven member is an output hub configured to engage in the centering cutout.

14. Hydrodynamic coupling device according to claim 12, wherein the guide disk element comprises a centering cutout in its radial inner area configured for engagement with an output hub.

15. The coupling arrangement according to claim 8, further comprising a flow path for supplying and removing pressure fluid from a pressure fluid space, the pressure fluid space defined by the piston element, wherein the flow path is formed by at least the guide disk element and the housing.
